(19) United States
(12) Patent Application Publication
(10) Pub. No.: US 2023/0404115 A1
(43) Pub. Date: Dec. 21, 2023

(54) METHOD FOR REMOVING THE STICKINESS OF GLUTINOUS RICE

(71) Applicant: Hangzhou Yu, Lianyungang (CN)

(72) Inventor: Hangzhou Yu, Lianyungang (CN)

(21) Appl. No.: 17/846,996

(22) Filed: Jun. 22, 2022

(30) Foreign Application Priority Data
May 24, 2022 (CN) 202210575010.2

(51) Int. Cl. A23L 5/20; A23L 7/196

(52) U.S. Cl. CPC A23L 5/21; A23V 2002/00; A23L 7/196

(57) ABSTRACT

The invention discloses a method for removing the stickiness of glutinous rice, specifically comprising the following steps: 1) soaking and rinsing; 2) heating and drying; 3) drying the glutinous rice to finish the final product. The invention has the following advantages: realizing the simple procedures and the easy implementation; dissolving the starch during soaking steps, repeatedly rinsing the starch which has been dissolved in hot water attached on the surface of glutinous rice, and then drying the surface water with the heat gun to achieve the purpose of grain separation; the tools and equipment used in the operation process to be frequently-used and readily available, achieving the manual and mechanized implementation; the flexible operation and wide range of application, realizing a good marketing value.

### 1. TECHNICAL FIELD

The invention relates to the technical field of food processing, in particular to a method for removing the stickiness of glutinous rice.

### 2. BACKGROUND ART

The stickiness of glutinous rice is contributed by the starch properties contained in glutinous rice. Rice contains starch consisting of many glucose molecules. The starch comprises two elements: amylose consisting of about 500 glucose molecules linked together in a straight line; and amylopectin consisting of more than 1,000 glucose molecules arranged in the branching structure. Rice with high amylopectin content tends to be much stickier after being cooked. On the contrary, rice with low amylopectin content tends to be less sticky after being cooked.

While many people are uncomfortable with the sticky taste of glutinous rice, the stickiness of glutinous rice leads to different contact surfaces, thus often resulting in uneven heating of glutinous rice, which cannot be easily cooked.

Therefore, it is urgent to explore a method for removing the stickiness of glutinous rice.

### 3. SUMMARY OF THE INVENTION

To solve the above problems in the background of the prior art, the invention intended to provide a method for removing the stickiness of glutinous rice.

To achieve the above aims, the invention provides a technical solution: provide a method for removing the stickiness of glutinous rice, specifically comprising the following steps:

1) soaking and rinsing: rinsing the dry glutinous rice to remove impurities; rinsing the glutinous rice with normal temperature water to remove impurities after soaked in the warm water; then draining it for subsequent use;

2) heating and drying: providing the above glutinous rice into a metal container, and heating the top opening of the metal container to dry the glutinous rice with the heat gun; constantly shaking the metal container during the heating process, to guarantee that all sides of the glutinous rice grain are exposed to the heated air and thus to separate each glutinous rice grain;

3) drying the glutinous rice to finish the final product: continuing the above drying process until the surface of glutinous rice achieves a state of no water and no stickiness, which completes the removal of the stickiness of glutinous rice.

Preferably, the draining procedure in step 1) is supposed to be continued until no water drops dripping from the bottom of the container.

Preferably, the temperature of the warm water provided for soaking in step 1) is lower than the gelatinization temperature of the glutinous rice.

Preferably, the metal container in step 2) is a stainless-steel tank.

Preferably, the heat gun in step 2) is an electric heat gun, and the diameter of the heat gun outlet is smaller than the diameter of the metal container.

Compared with the prior art, the invention has the following advantages: realizing the simple procedures and the easy implementation; dissolving the starch by soaking steps, repeatedly rinsing the starch which has been dissolved in hot water attached on the surface of glutinous rice, and then drying the surface water with the heat gun to achieve the purpose of grain separation; the tools and equipment used in the operation process to be frequently-used and readily available, achieving the manual and mechanized implementation; the flexible operation and wide range of application, realizing a good marketing value.

### 4. SPECIFIC EMBODIMENT OF THE INVENTION

To make the technical solutions provided by the invention more comprehensible, a further description of the invention is given below in combination with the attached drawings and embodiments. The embodiments are exemplary and not the limitations of the scope of the disclosure.

A method for removing the stickiness of glutinous rice, specifically comprising the following steps:

1) soaking and rinsing: rinsing the dry glutinous rice to remove impurities; rinsing the glutinous rice with normal temperature water to remove impurities after soaked in the warm water; then draining it for subsequent use;

2) heating and drying: providing the above glutinous rice into a metal container, and heating the top opening of the metal container to dry the glutinous rice with the heat gun; constantly shaking the metal container during the heating process, to guarantee that all sides of the glutinous rice grain are exposed to the heated air and thus to separate each glutinous rice grain;

3) drying the glutinous rice to finish the final product: continuing the above drying process until the surface of glutinous rice achieves a state of no water and no stickiness, which completes the removal of the stickiness of glutinous rice.

Specific implementation method: dissolving the starch by the steps of soaking, repeatedly rinsing the starch which has been dissolved in hot water attached on the surface of glutinous rice, and then drying the surface water with the heat gun to achieve the purpose of grain separation; the tools and equipment used in the operation process to be frequently used and readily available, achieving the manual and mechanized implementation, with the flexible operation and wide range of application. The containers, tools and equipment provided in the invention are frequently used and readily available. For instance, the heat gun according to the claim, can adopt an L-type electric heat gun, with a voltage of 220V, frequency of 50-60 Hz and power of 2500 W, the temperature of the heat gun can reach up to 600° C., with the air volume of 300-600 L per minute, size of 290 mm×205 mm×75 mm and air outlet diameter of 20 mm.

The finished glutinous rice without stickiness is available for various cooking methods such as boiling, steaming, baking, and frying.

The above description of the invention and the embodiments thereof is not restricted, and the accompanying drawings are only one of the embodiments of the invention, and the actual structure is not limited thereto. In conclusion, the similar structures and embodiments with the technical scheme of the invention, which are designed by the general skilled person in the art inspired by the invention, without creativity and without departing from the spirit of the invention, should be included in the protection scope of the invention.

What is claimed is:

1. The method for removing the stickiness of glutinous rice, wherein comprises the following steps:
1) soaking and rinsing: take the dried glutinous rice and put it into a container with the grid at the bottom, rinse it with normal temperature water to remove impurities, then put the glutinous rice into an uncovered container and soak it in warm water, put the soaked glutinous rice back into the container with the bottom grid, and rinse it with normal temperature water remove impurities and drain for later use;
2) heating and drying: providing the above glutinous rice into a metal container, use a heat gun to open the top of the metal container, and the hot air directly contacts the rice grains to bake and dry, constantly shaking the metal container during the heating process, to guarantee that all sides of the glutinous rice grain are exposed to the heated air and thus to separate each glutinous rice grain;
3) drying the glutinous rice to finish a final product: continuing the above drying process until surface of glutinous rice achieves a state of no water and no stickiness, which completes the removal of the stickiness of glutinous rice.

2. The method for removing the stickiness of glutinous rice according to claim 1, wherein draining procedure in step 1) is continued until no water drips from the bottom of the metal container.

3. The method for removing the stickiness of glutinous rice according to claim 1, wherein a temperature of the warm water provided for soaking in step 1) is lower than the gelatinization temperature of the glutinous rice.

4. The method for removing the stickiness of glutinous rice according to claim 1, wherein a metal container in step 2) is a stainless-steel tank.

5. The method for removing the stickiness of glutinous rice according to claim 1, wherein the heat gun in step 2) is an electric heat gun, and a diameter of the heat gun outlet is smaller than a diameter of the metal container.
